(19) United States
(12) Patent Application Publication
(10) Pub. No.: US 2026/0245053 A1
(43) Pub. Date: Aug. 20, 2026

(54) Method and Device for Creating a Technical Specification, in particular for Use in Monitoring and Error Diagnosis

(71) Applicant: Robert Bosch GmbH, Stuttgart (DE)

(72) Inventors: Bernd Mueller, Reutlingen (DE); Christian Pfahler, Tuebingen (DE)

(21) Appl. No.: 19/536,632

(22) Filed: Feb. 11, 2026

(30) Foreign Application Priority Data
Feb. 17, 2025 (DE) 10-2025 105 902.0

(51) Int. Cl. G06Q 10/40; G10L 15/22

(52) U.S. Cl. CPC G06Q 10/40; G10L 15/22

(57) ABSTRACT

A computer-implemented method for creating a technical specification for a technical product includes (i) providing a product description, (ii) using a first technical assistant comprising a data-based language model, wherein the first technical assistant is configured to determine detail elements and parameters for their attributes for a higher requirements level based on the product description, as a partial specification of the higher requirements level, (ii) using a linking assistant comprising a data-based language model that is configured to determine detail elements of at least one subordinate requirements level along with their attributes and parameters, for the determined detail elements of the higher requirements level, (iii) using at least one second technical assistant comprising a data-based language model that is configured to determine the attributes and parameters of the determined detail elements of the at least one of the subordinate requirements level, as a partial specification, and (iv) generating the technical specification from the partial specifications.

This application claims priority under 35 U.S.C. § 119 to patent application no. DE 10 2025 105 902.0, filed on Feb. 17, 2025 in Germany, the disclosure of which is incorporated herein by reference in its entirety.

The disclosure relates to technical specifications of complex products, such as vehicles, and in particular to methods for creating such a technical specification.

### BACKGROUND

Technical specifications are created in the industry over several levels of detail using a top-down approach (so-called V model). In creating these specifications, information derived from the requirements stage through the concept, design, and verification stages all the way through implementation stage with the associated tests is added little by little along with more and more details on the technical implementation and the safeguarding of such implementation. At the same time, there is segmentation across different specialty areas. For example, the ISO26262 standard common in the automotive industry regulates how this derived information and details proceed according to the V model: Vehicle level->system and architecture level->division between hardware and software level->hardware implementation, software implementation—each with testing->joint implementation of hardware and software plus testing.

Methods and tools are commonly used with this derived information to help structure the requirement details of the respective levels (database solutions) as well as to provide a link between the levels (documenting the so-called traceability). The link represents a semantic relationship of the different levels and is based on a logical link or derivation from the different levels.

These steps, and in particular the aforementioned link, are usually performed manually in the industry by the creator of the respective documentation. Often, the different detail levels described are represented by different professional disciplines in a complex team structure, so that several people are necessary to create them, with each manually creating the documents and also manually ensuring the consistency of the link. Since all of these steps may be prone to errors, further manual verification is also required.

Technical specifications often specify default parameters, for example voltage ranges and the like, which the monitoring methods and diagnostic methods to be implemented must be based on in order to determine whether there are no errors or there is an error, and to enable pinpointing of an error that has occurred, if applicable.

It is the object of the present disclosure to provide a method for simplified and automated creation of a technical specification for complex products at multiple requirement levels of the V model.

### SUMMARY

This object is achieved with the method of creating a technical specification for a technical product according to the description set forth below, as well as by the device according to the description set forth below.

Further embodiments are also described below.

In a first aspect, a computer-implemented method for creating a technical specification for a technical product is provided, with the steps of:
providing a product description;
using a first technical assistant comprising a data-based language model, wherein the first technical assistant determines detail elements and parameters for their attributes for a higher requirements level based on the product description, as a partial specification of the higher requirements level;
using a linking assistant comprising a data-based language model that is configured to determine detail elements of at least one subordinate requirements level along with their attributes and parameters, for the determined detail elements of the higher requirements level;
using at least one second technical assistant comprising a data-based language model that is configured to determine the attributes and parameters of the determined detail elements of the at least one of the subordinate requirements level, as a partial specification;
generating the technical specification from the partial specifications.

Preferably, a product is produced based on the generated specification.

The above method allows for simplified use of large language models to create a technical specification for a technical product. To this end, the development of the technical specification is carried out in accordance with the V model, which divides the characteristics of the technical product into multiple requirements levels, such as product level, system and architecture level, hardware and software level, implementation level. The specification is composed of partial specifications, each corresponding to or depicting or describing a requirements level, and is linked so that a subordinate requirements level always relates to elements of the superordinate requirements level. It is proposed to create the partial specifications by way of corresponding large language models (transformer models) and also create the link between the requirements levels using a large language model.

Utilizing large language models to create the partial specifications of the individual requirements levels of the top-down approach of the V model allows for a compilation of the technical elements or components (detail elements) applicable to or contained in the technical product and the associated technical data (attributes and parameters of the attributes). In addition, using a linkage model, which can also be configured as a large language model, the requirements levels are connected to one another so that the relationship of the individual elements or components of the requirements levels to each other may be depicted in the specification.

This enables the creation of the technical specification in an automated manner and thus without the intervention of developers. The specification creation is performed using associated technical assistants associated with the requirements levels, which can each correspond to a language model. These technical assistants or language models can be created by training them on pre-existing technical specifications of a particular requirements level. For example, in the case of a vehicle as a technical product at the vehicle level, a first technical assistant may be provided to be trained on the already existing technical specifications of that particular requirements level.

The first technical assistant is trained by teaching it examples of technical specifications as well as the existing technical language of the respective requirements level in addition to technical details and attributes, such as relevant parameters and associated variables. The technical assistant also captures the classifications of the individual technical details and can, in the process, capture cluster assignments, for example in functions.

A second technical assistant may be responsible for a further requirements level of the technical specification, the architecture of which second assistant essentially corresponds to the first technical assistant, i.e., it is also configured as a large language model and has been trained on examples of a different requirements level of the technical specification.

A technical linking assistant is provided that acts as a liaison between the technical assistants of different requirements levels. The technical linking assistant is trained to link requirements from one requirements level to the next requirements level.

This exploits the ability of large language models (LLM) to mathematically capture the semantic and linguistic relationships via a further training process using existing historical data from both involved requirements levels and their links. By way of statistical methods of the underlying transformer models of the LLMs, the most likely possibility of a link is learned in the training process or stored in the model by way of parameterization. An adjustment of the transformer model of the LLM is technically conceivable and may optionally be considered to optimize the operation.

The linking assistant establishes the links between two requirements levels and thus establishes the semantic relationship between the requirements levels involved (traceability). The linking may be of a 1:n logic. That is to say, based on one requirement at a higher level, one or more requirements may result at the level below, as more and more details typically need to be added to a technical implementation in the subordinate step. As a matter of technical implementation, this link could be by way of a translation table or representation of an ID-to-ID mapping, wherein each ID represents one requirement at a requirements level.

Where appropriate, the links are broken down into multiple equivalent requirements levels, such as the hardware and software levels, which are hierarchically equivalent. The technical linking assistant may thus, based on a requirements level, semantically create or suggest derived steps at an equivalent requirements level or at the next subordinate requirements level or a further subordinate requirements level.

In particular, creating the technical specification is accomplished by selecting a first technical assistant for a superordinate requirements level that proposes a first partial specification for a function or element of the relevant requirements level based on a requirements level description. The linking assistant uses the partial specification and suggests a possible derivation of it for a requirements level that is subordinate to it. The second technical assistant associated with the subordinate detail level then proposes a specification for a function or element of the relevant detail level.

In particular, it is contemplated that the technical assistants and the linking assistant are implemented on a common infrastructure. If all technical assistants and the linking assistant are available in a trained manner, they can be used to create new specifications or improve existing technical specifications. Also, the technical assistants may be used to suggest what to specify at the particular requirements level based on a user query. In large language models, the user query is not limited to a particular form, and may be provided interactively or by providing an unstructured collection of requirements (in any file formats or database) or a combination of multiple methods. The user query may also be supported in that a technical assistant asks the user questions to obtain information necessary to create the partial specification.

If a partial specification is created for a particular requirements level, in a next step, the linking assistant can analyze that partial specification and suggest a possible derivation of it at subordinate requirements levels. This then serves as an input to the second technical assistant for the subordinate requirements level, which then creates a subordinate requirements level partial specification based on that.

This process can be repeated multiple times to create partial specifications for all possible requirements levels. These are then joined together according to the links between the requirements levels.

In addition, it is contemplated that the first technical assistant may make content adjustments to the specification at its assigned requirements level that would need to be confirmed by the user. The goal of the adjustments is to match the user requirement to already existing/known other specifications. For example, if the user of the first technical assistant does not adopt proposed adjustments, these differences could be identified as novel items and displayed/documented accordingly.

Furthermore, the linking assistant, in conjunction with the second technical assistant, could offer different/alternative specifications for the subordinate requirements level. For example, it could be considered which known products already exist that fully or substantially meet the requirements of the higher requirements level. Or, as an alternative, a deviation in the content of the specification of the subordinate requirements level can be displayed from the requirements of the higher requirements level (“deviation list”). Alternatively, a selection from different specifications may be displayed, which is probably a preferred specification (i.e., which is the most likely specification based on learned criteria).

It is also optionally conceivable for the user to decide on whether to accept/reject various suggestions. The decision is not made across the board for the entire specification, but the user can select the granularity at which the decision is made. The second technical assistant could, for example, first identify the differences from the known specifications of existing products to the user via the final specification of the subordinate requirements level (level of novelty).

After the user decision, the linking assistant could create a deviation list, showing which requirements of the partial specification of the higher requirements level are not, or not completely, met by the partial specification of the subordinate requirements level.

In order for the partial specification of the subordinate requirements level to account for multiple (if necessary, independent) partial specifications of the higher requirements level, the “parallel” partial specifications of the same requirements level may be considered as all being able to be covered by the second technical assistant in one specification of the subordinate requirements level. The linking assistant can show any existing contradictions between the partial specifications of the higher requirements level. The user could decide on how to meet/not meet the higher level specifications based on the suggestions from the linking assistant and the second technical assistant.

According to a further aspect, a method for training an assistant for use in one of the methods above is provided, wherein the first technical assistant is trained to generate a set of first detail items and their attributes and parameters on the basis of a product description, and/or wherein the linking assistant is trained to identify detail elements associated with one or more subordinate requirements levels on the basis of detail elements of a higher requirements level, and/or wherein the second technical assistant is trained to determine, on the basis of identified detail elements of a respective subordinate requirements level, parameters for attributes of such detail elements of a higher requirements level.

### BRIEF DESCRIPTION OF THE DRAWINGS

Preferred embodiments are described in more detail below with reference to the accompanying drawings. It shows:

FIG. 1 a schematic illustration of a computer system having a database for performing the method of creating a technical specification for a technical product;

FIG. 2 a flow chart for depicting the process of creating a technical specification using the technical assistants and the linking assistant, and

FIG. 3 a schematic representation of the interplay of the technical assistants and the linking assistant for creating a technical specification using the example of two requirements levels.

### DETAILED DESCRIPTION

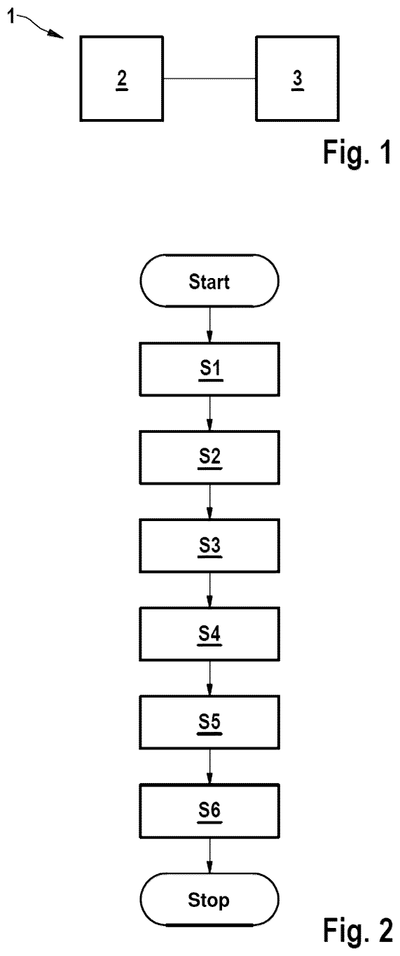

FIG. 1 schematically shows a platform 1 for creating a technical specification with a data processing device 2 and a database 3 for storing the data-based models of technical assistants. The database 3 stores model parameters for a first technical assistant, at least a second technical assistant, and at least one linking assistant, which are retrieved as needed from the data processing facility and used to execute the respective models. The models typically correspond to language models, in particular a transformer model or a large language model, and allow the creation of a technical specification for the product on the basis of a product description.

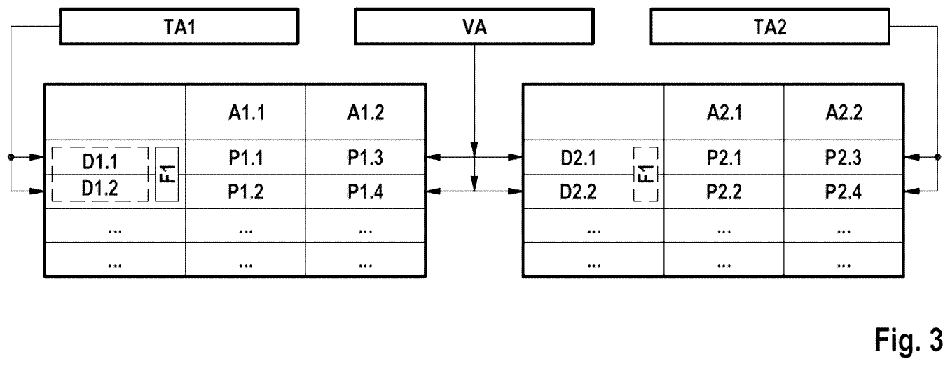

FIG. 2 shows a flow chart for using the above platform to create a technical specification. The method is illustrated in the schematic diagram of FIG. 3. FIG. 3, for this purpose, shows the application of the first and the second technical assistant for a higher requirements level and a subordinate requirements level, as well as the linking assistant for the higher requirements level and/or the subordinate requirements level of a technical specification according to a V model. The number of requirements levels is not limited to two and may include further hierarchically arranged requirements levels.

For this purpose, in step S1 a product description is provided for the product, for which a specification is to be created.

If, for example, a voltage range for a voltage in a technical system is specified at a higher requirements level, which is to result in a defined reaction if the voltage is above or below this range, one or more learned monitoring methods or diagnostic methods to be implemented could be proposed. The user could then decide on an option.

In step S2, a partial specification for a higher requirements level is created using the first technical assistant TA1. FIG. 3 shows the detail elements D1, D2 of the product for the partial specification created in this way. These detail elements D1.1, D1.2 are described with attributes A1.1, A1.2 that are determined from parameters P1.1, P1.2, P1.3, P1.4 in order to thus generate a partial specification.

In step S3, the linking assistant VA is used to determine elements and/or components for the detail elements D1.1, D1.2, etc., i.e., detail elements D2.1, D2.2, etc., of a subordinate requirements level, with which the detail elements D1.1, D1.2, etc. are associated. The detail elements can serve as an input for the linking assistant, which assigns additional subordinate detail elements of the subordinate requirements level to the detail elements.

In step S4, using the second technical assistant TA2, the identified elements and/or components of the subordinate requirements level are described as a partial specification by corresponding attributes A2.1, A2.2, etc. and the parameters P2.1, P2.2, P2.3, P2.4, etc. associated with these attributes.

In step S5, the partial specifications are summarized for the specification to be determined for the product.

In step S6, a test or verification method for the product and its components can be performed based on the specification thus created in an automated manner, wherein parameters, for example, can be specified as limit values for test queries.

For more than two requirements levels, a separate technical assistant is provided for each, and a corresponding linking assistant is provided so that the above method can be performed for all requirements levels.

Utilization of the large language models forming the technical assistants TA1, TA2 may be supported by prompts that specify which detail elements should be present or not present. Furthermore, the large language models may also make inquiries of the user to interactively define the partial specifications.

To train the large language models for the different requirements levels to create respective partial specifications, a variety of already existing technical specifications along with associations with detail elements and the product specification can be provided. Training is done separately in a known manner for large language models for the requirements levels, wherein the first technical assistant defines detail elements for the main level based on a product specification, which are further specified at downstream levels. This occurs by way of one or more second technical assistants that receive one or more detail elements as an input from the respective higher requirements level and further specify them. The linking assistant allows the detail elements from the higher requirements level to be linked to detail elements of one or more subordinate requirements levels and is trained accordingly by providing sample specifications, in which these links are identified.

What is claimed is:

1. A computer-implemented method for creating a technical specification for a technical product, comprising:
providing a product description;
using a first technical assistant comprising a data-based language model, wherein the first technical assistant is configured to determine detail elements and parameters for their attributes for a higher requirements level based on the product description, as a partial specification of the higher requirements level;
using a linking assistant comprising a data-based language model that is configured to determine detail elements of at least one subordinate requirements level along with their attributes and parameters, for the determined detail elements of the higher requirements level;
using at least one second technical assistant comprising a data-based language model that is configured to determine the attributes and parameters of the determined detail elements of the at least one of the subordinate requirements level, as a partial specification; and
generating the technical specification from the partial specifications.

2. The method according to claim 1, wherein the detail elements comprise elements and/or functions and/or components of the technical product.

3. The method according to claim 1, wherein the creation of the partial specifications is interactive by prompts of a user input or a user query by the respective assistant.

4. The method according to claim 1, wherein the linking assistant offers alternative partial specifications of the subordinate requirements level and uses the ones to which a user has consented.

5. The method according to claim 1, wherein the technical assistants and the linking assistant are configured as large language models.

6. A method for training an assistant for use in the method according to claim 1, wherein the first technical assistant is trained to generate a set of first detail items and their attributes and parameters on the basis of a product description, and/or wherein the linking assistant is trained to identify detail elements associated with one or more subordinate requirements levels on the basis of detail elements of a higher requirements level, and/or wherein the second technical assistant is trained to determine, on the basis of identified detail elements of a respective subordinate requirements level, parameters for attributes of such detail elements of a higher requirements level.

7. A device for carrying out the method according to claim 1.

8. A computer program product comprising instructions which, when executed by at least one data processing device, cause the device to perform the steps of the method according to claim 1.

9. A machine-readable storage medium comprising instructions which, when executed by at least one data processing device, cause the device to perform the steps of the method according to claim 1.
